(19) United States
(12) Patent Application Publication
(10) Pub. No.: US 2024/0042969 A1
(43) Pub. Date: Feb. 8, 2024

(54) DEVICE FOR CLEANING AN OPTICAL SURFACE

(71) Applicants: UNIVERSITE DE LILLE, Lille (FR); CENTRALE LILLE INSTITUT, Villeneuve d'Ascq (FR); UNIVERSITE POLYTECHNIQUE HAUTS-DE-FRANCE, Valenciennes (FR); Centre National de la Recherche Scientifique, Paris (FR); Valeo Systèmes d'Essuyage, Le Mesnil Saint Denis (FR)

(72) Inventors: Michaël Baudoin, Villeneuve d'Ascq (FR); Ravinder Chutani, Lille (FR); Frederic Bretagnol, Le Mesnil Saint Denis (FR); Adrien Peret, Le Mesnil Saint Denis (FR)

(73) Assignee: Valeo Systèmes d'Essuyage, Le Mesnil Saint Denis (FR)

(21) Appl. No.: 18/267,357

(22) PCT Filed: Dec. 13, 2021
(86) PCT No.: PCT/EP2021/085494

§ 371 Date: Jun. 14, 2023

(30) Foreign Application Priority Data
Dec. 14, 2020 (FR) FR2013210

(51) Int. Cl. B60S 1/56; B08B 7/02

(52) U.S. Cl. CPC B60S 1/56; B08B 7/028

(57) ABSTRACT

Disclosed is a device (5) for cleaning an optical surface, which device comprises: —a transparent optical surface (10); —a cleaning unit (15) for cleaning the optical surface, having a piezoelectric layer (20) and at least two wave transducers (45), each wave transducer having electrodes (40) of opposite polarity in contact with the piezoelectric layer and being acoustically coupled to the optical surface so as to generate at least one surface ultrasonic wave (Wₛ) or a Lamb wave (W_{L}) propagating in the optical surface, the transducers being further arranged on the periphery of the optical surface.

The present invention relates to a device for cleaning away a body in contact with an optical surface using ultrasonic waves.

In various fields, it is necessary to overcome the effects associated with the buildup of a body, notably raindrops, ice or snow, on an optical surface.

It is known practice to cause drops of a liquid to rotate in order to remove them from a surface. However, such a technique is not suitable for surfaces the area of which is greater than a few square centimeters.

The use of an electrical field to control the hydrophobic property of a surface is also known, for example from KR 2018 0086173 A1. This technique, known by the acronym EWOD (which stands for ElectroWetting On Devices) consists in applying a potential difference between two electrodes so as to electrically polarize the surface and change the wetting properties thereof. By controlling the location of the polarization, the drop can then be moved. However, this technique can be implemented only with specific materials and requires the electrodes to be positioned particularly precisely over the entire surface the wetting properties of which are to be controlled.

It is also well-known practice to apply a mechanical force to the liquid, for example by means of a wiper on the windshield of a motor vehicle. However, a wiper limits the field of view accessible to the driver. It also spreads the greasy particles deposited on the surface of the windshield. In addition, the wiper blade rubbers need to be replaced regularly.

WO 2015/011064 A1 describes a device for cleaning a windshield using ultrasonic surface waves. However, the device in WO 2015/011064 is complex to manufacture because it requires bonding a considerable number of transducers to the windshield.

There is therefore a need for a device for removing a body from an optical surface and which is easy to manufacture.

The invention seeks to meet this need and proposes a device comprising:
a transparent optical surface,
an optical-surface cleaning unit comprising a piezoelectric layer and at least two wave transducers,
each wave transducer comprising electrodes of opposite polarities in contact with the piezoelectric layer, and being acoustically coupled with the optical surface in order to generate at least one ultrasonic surface wave or a Lamb wave propagating in the optical surface,
the transducers further being arranged at the periphery of the optical surface.

The device according to the invention thus allows the optical surface to be cleaned effectively by causing one or more bodies, for example drops of water, that are covering the optical surface to move by causing the propagation of ultrasonic surface waves or Lamb waves.

Furthermore, the device is easy to manufacture. For example, a piezoelectric layer is first of all deposited on, for example bonded to, the optical surface, and then the electrodes of the various transducers are deposited on the piezoelectric layer in a single step, for example using printing or screen printing. Moreover, the fact that they are positioned at the periphery of the optical surface makes it easier for the transducers to be protected, for example by means of a structure supporting the optical surface and which may cover the transducers.

What is usually meant by a “layer” is a uniform expanse applied to or deposited on a surface.

As a preference, each wave transducer extends from an edge of the optical surface over a distance less than 10%, or even less than 5% of the length of the optical surface. What is meant by the “length of the optical surface” is the distance separating two opposite edges of the optical surface along one face of the optical surface.

As a preference, each wave transducer extends from an edge of the optical surface over a distance less than 30 mm, preferably less than 20 mm, preferably less than 10 mm.

The wave transducers are preferably in contact with the optical surface.

The wave transducers may be fixed to the optical surface in various ways.

For example, the wave transducers may take the form of a foil which is transferred onto the optical surface. What is meant by a “foil” is a thin, flexible film, notably having a thickness less than 100 μm.

The transducers may be bonded to the optical surface, notably by means of a polymer adhesive which also acoustically couples the transducers to the optical surface. The adhesive may be UV-curable. It is, for example, an epoxy resin. The transducers may be attached by molecular adhesion or by means of a thin metal layer that sticks the optical surface to the piezoelectric layer. The layer may be made from a metal or an alloy having a low melting point, i.e. having a melting point below 200° C., for example an indium alloy. As an alternative, the metal layer may be made from a metal or an alloy having a melting point higher than 200° C., for example an aluminum and/or gold alloy.

An example of bonding via molecular adhesion is described in “Glass-on-LiNbO₃ heterostructure formed via a two-step plasma activated low-temperature direct bonding method”, J. Xu et al., Applied Surface Science 459 (2018) 621-629, doi: 10.1016/j.apsusc.2018.08.031. In another alternative, the transducers may be fixed to the optical surface by means of a method comprising a step of melting a portion of the piezoelectric layer and/or a portion of the optical surface, followed by a step consisting of compressing the piezoelectric layer and the optical surface together, the respective molten portions of the optical surface and of the piezoelectric layer being in contact with one another. In another alternative, the transducers may be fixed to the optical surface by means of a method comprising depositing bonding layers made from a low melting-point alloy on a portion of the transducer and to a portion of the optical surface respectively, at least partially melting said bonding layers, then compressing the piezoelectric layer and the optical surface, the faces of the bonding layers that are the opposite faces from those facing the optical surface and the piezoelectric layer being brought into contact with one another during the compression. The bonding layers may be deposited by cathodic sputtering, or using an evaporation technique used in the field of the depositing of thin layers.

As a preference, the piezoelectric layer takes the form of a strip which extends over one face of the optical surface, for example between two opposite edges of the optical surface. As a preference, the strip extends along one edge of the optical surface, and preferably parallel to said edge.

In particular, the optical surface may comprise a region of optical interest that is not superposed with the transducers and the piezoelectric layer may form a surround at least partially, and notably completely, framing the region of optical interest. The exterior contour and/or the interior contour of the surround may be homothetic with the contour of that face of the optical surface on which the piezoelectric layer is arranged.

The thickness of the piezoelectric layer may be selected according to the wavelength λ of the ultrasonic surface wave. As a preference, the thickness of the piezoelectric layer is less than or equal to 5*λ, preferably less than or equal to 1.5*λ, preferably less than or equal to λ, or even less than or equal to 0.5*λ, notably for an ultrasonic surface wave with a frequency comprised between 0.1 MHz and 60 MHz.

The piezoelectric layer may have a thickness comprised between 1 μm and 300 μm. It may have a thickness less than or equal to 100 μm, less than 50 μm or even less than 10 μm.

The ratio of the thickness of the optical surface to the thickness of the piezoelectric layer is preferably greater than 2, preferably greater than 10, or even greater than 50.

The layer may be deposited on the optical surface using a method selected from physical vapor deposition, chemical vapor deposition, magnetron sputtering and electron cyclotron resonance.

The piezoelectric layer may be made from a material selected from the group formed by lithium niobate, aluminum nitride, zinc oxide, lead zirconate titanate, and mixtures thereof.

The piezoelectric layer may be opaque to light. The surround may thus encourage an observer to focus their gaze through the region of optical interest.

In an alternative, the piezoelectric layer may be transparent. Thus, the transducers may seem invisible to the user.

What is meant by “transparent” is transparency to light radiation in the visible and/or to radiation in the infrared and/or to radiation in the ultraviolet.

The electrodes of each transducer have opposite polarities, which is to say that they are intended to be electrically powered with electrical voltages of opposite signs.

The opposite-polarities electrodes of each transducer may each have a comb comprising a branch from which fingers extend. The combs are preferably interdigital.

Each of the fingers of a comb may have a width equal to the fundamental wavelength of the ultrasonic surface wave or the Lamb wave, divided by 4, and the spacing between two consecutive fingers of a comb may be equal to the fundamental wavelength of the ultrasonic surface wave or of the Lamb wave, divided by 4. The spacing between the fingers determines the resonant frequency of the transducer which a person skilled in the art is easily capable of determining Applying alternating electrical voltages to the electrodes of opposite polarities induces a mechanical response in the piezoelectric material, resulting in the generation of an ultrasonic surface wave or of a Lamb wave, which propagates in the optical surface.

The electrodes may be made of metal. They may be made of chromium, or aluminum or a combination of an adhesion-promoting layer such as titanium with a conducting layer such as gold.

In alternatives, the electrodes may be made from a conducting transparent oxide, for example selected from indium tin oxide, aluminum-doped zinc oxide, and mixtures thereof. In particular, each transducer may be transparent and formed from such electrodes and from a transparent piezoelectric layer made of lithium niobate or zinc oxide.

The electrodes may be applied to the piezoelectric layer by an evaporative or sputtering process and shaped using photolithography.

They may be printed, for example using ink-jet printing, notably onto the piezoelectric layer. In particular, they may be printed on a foil, for example made from a flexible thermoplastic material, and be applied by transferring the foil onto the piezoelectric layer. Such a method for transferring the electrodes is particularly simple to implement.

The transducer may be configured to emit an ultrasonic surface wave or a Lamb wave with a fundamental frequency that may be comprised between 0.1 MHz and 1000 MHz, preferably comprised between 10 MHz and 100 MHz, for example equal to 40 MHz, and/or with an amplitude that may be comprised between 1 nanometer and 500 nanometers. The amplitude of the wave corresponds to the normal displacement of the face of the optical surface over which the ultrasonic surface wave is propagating. It can be measured using laser interferometry.

The ultrasonic surface wave may be a Rayleigh wave, when the optical surface has a thickness greater than the wavelength of the ultrasonic surface wave. A Rayleigh wave is preferred because a maximum proportion of the wave energy is concentrated on the face of the optical surface over which it is propagating, and can be transmitted to a body, for example a raindrop, lying on the optical surface.

As a preference, the device comprises more than two transducers, for example more than five, or even more than ten transducers.

The transducers may be configured to emit acoustic surface waves that propagate in directions that are parallel or that are secant. For example, the device comprises at least three transducers which are configured so that the directions of propagation of the waves that they are able to generate intersect at a common location.

The transducers may be evenly distributed over the contour of the face of the optical surface on which they are arranged.

The optical surface may be self-supporting, in the sense that it is able to deform, notably elastically, without breaking under its own self-weight.

That face of the optical surface over which the ultrasonic surface wave or the Lamb wave emitted by each transducer propagates may be planar. It may also be curved, provided that the radius of curvature of the face is greater than the wavelength of the ultrasonic surface wave. Said face may be rough. The roughness lengths are preferably shorter than the fundamental wavelength of the ultrasonic surface wave, so as to avoid their significantly affecting the propagation thereof.

The optical surface may take the form of a sheet that is planar or that has at least one curvature in one direction. The thickness of the optical surface may be comprised between 100 μm and 5 mm. The length of the plate may be greater than 1 mm, or even greater than 1 cm, or even greater than 1 m.

The “thickness of the optical surface” considers the shortest dimension of the optical surface as measured in a direction perpendicular to the surface over which the ultrasonic surface wave or the Lamb wave propagates.

The optical surface may be set out flat relative to the horizontal. As an alternative, it may be inclined with respect to the horizontal by an angle α greater than 10°, or even greater than 20°, or even greater than 45°, or even greater than 70°. It may be set out vertically.

The optical surface is preferably transparent at least to light in the visible part of the spectrum. As a preference, it is opaque to radiation in the ultraviolet or to radiation in the infrared.

Moreover, the optical surface may have a single-layer or multi-layer coating covering one face of the acoustically conducting portion.

The coating may notably include a hydrophobic layer, an antireflection layer, or a stack of these layers. For example, the hydrophobic layer consists of self-assembled single layers of OTS or may be produced by deposition of a fluorine-based plasma. The coating may contain one or more antireflection coating layers depending on the intended application (visible, IR, etc.).

Each transducer may be in contact with the acoustically conducting portion and the hydrophobic layer may completely cover the transducer, in order to protect it from contact with water. In an alternative, the coating is positioned between the transducer and the acoustically conducting portion.

As a preference, the optical surface comprises an acoustically conducting portion, each transducer being acoustically coupled to, and preferably in contact with, the acoustically conducting portion.

The acoustically conducting portion is preferably transparent.

The acoustically conducting portion preferably has an attenuation length greater than the length of the optical surface, or even greater than 10 times the length of the optical surface, or actually even greater than 100 times the length of the optical surface.

The acoustically conducting portion may be made from any material capable of propagating an ultrasonic surface wave or a Lamb wave. As a preference, it is made from a material having an elastic modulus greater than 1 MPa, for example greater than 10 MPa, or even greater than 100 MPa, or actually even greater than 1000 MPa, or indeed even greater than 10,000 MPa. A material exhibiting such an elastic modulus has a stiffness particularly suited to the propagation of an ultrasonic surface wave or of a Lamb wave.

As a preference, the acoustically conducting portion is made of glass or of poly(methyl methacrylate), also known by the trade name of Plexiglas®.

The optical surface may consist of the acoustically conducting portion.

In an alternative, the optical surface may comprise an acoustically insulating portion, which is to say a portion that absorbs the ultrasonic surface wave or the Lamb wave, over a distance less than the length of the optical surface, or even less than 0.1 times the length of the optical surface. The acoustically insulating portion is preferably superposed with the acoustically conducting portion. The acoustically insulating portion may completely cover the acoustically conducting portion. As a preference, the acoustically insulating portion is made of polycarbonate. Other rubbery or plastic materials may be envisioned.

The acoustically insulating portion is preferably transparent.

In particular, the acoustically insulating portion and the acoustically conducting portion may be stacked one upon the other, and preferably in contact with one another. In particular, the acoustically conducting portion may have a thickness at least five times smaller than the thickness of the acoustically insulating portion. Thus, the acoustically insulating portion may confer mechanical strength upon the optical surface while the acoustically conducting portion makes it possible to perform the function of performing cleaning by carrying the ultrasonic wave.

The acoustically conducting portion may be mounted removably on the acoustically insulating portion. Thus, it is easily possible to replace one of said portions when it is damaged, for example following contact with a solid body, for example a stone, when the device is in motion.

In particular, the acoustically conducting portion may be bonded to the acoustically insulating portion using a reversible adhesive.

The device may be a motorcycle helmet comprising a shell intended to protect a user's skull and the optical surface may be a visor mounted on the shell so as to protect all or part of the motorcyclist's face.

The wave transducer may be completely or partially concealed from the sight of the user who has put their head inside the shell. The optical surface may be positioned between the wave transducers and the inside of the shell.

As an alternative, the device may be a glazed element of a building and the optical surface is glazing. In particular, the glazed element, for example an opening window, comprises a structure framing the optical surface. The optical surface may be positioned between the transducer and the inside of the building on which the glazed element is intended to be mounted.

In another alternative, the device is a motor vehicle, notably a motor car or a truck, and the optical surface is a windshield of the vehicle. The wave transducers may be concealed from the sight of an occupant of the vehicle sitting on a seat of the vehicle. The optical surface may be positioned between the transducers and a seat of the vehicle.

In another alternative, the device is an automated vehicle, notably a motor car or a truck, the optical surface covering an optical sensor and/or an optical emitter, for example a lidar, photographic equipment, a camera, a radar, an infrared sensor or an ultrasound telemeter.

In yet another alternative, the device is a component of a motor vehicle, notably automated, for example selected from a headlamp module, a system containing a collection of various sensors also referred to as a “pod”, at least one side window, a front screen or rear screen and a driving assist unit.

In particular, the device may comprise a cover completely or partially superposed over the transducers. In particular, the transducers may be protected by the cover. They may notably be completely covered by the cover and by the optical support.

For example, the shell of the helmet or the bodywork or the framing structure may comprise such a cover.

Moreover, the cleaning unit may comprise an electricity generator to electrically power each transducer, such that each transducer converts the electrical supply signal into an ultrasonic surface wave or into a Lamb wave.

The invention also relates to the use of a device according to the invention for removing a body that is in contact with the optical surface out of the region of optical interest.

The use may involve electrically powering the cleaning unit in order to melt the body when the body is in the solid state, and/or to keep the body in the liquid state when the temperature of the optical surface is below the temperature at which the body solidifies. The body is, for example, ice or snow.

The body in the liquid state may take the form of at least one drop or at least a film. The energy of the ultrasonic surface wave may be enough to cause the body in the liquid state to move over the face of the optical surface. The body may be aqueous, and is notably rainwater or condensation. The temperature of the optical surface may be below 0° C.

The invention may be better understood from reading the following detailed description of nonlimiting exemplary embodiments thereof, and from studying the appended drawings, in which:

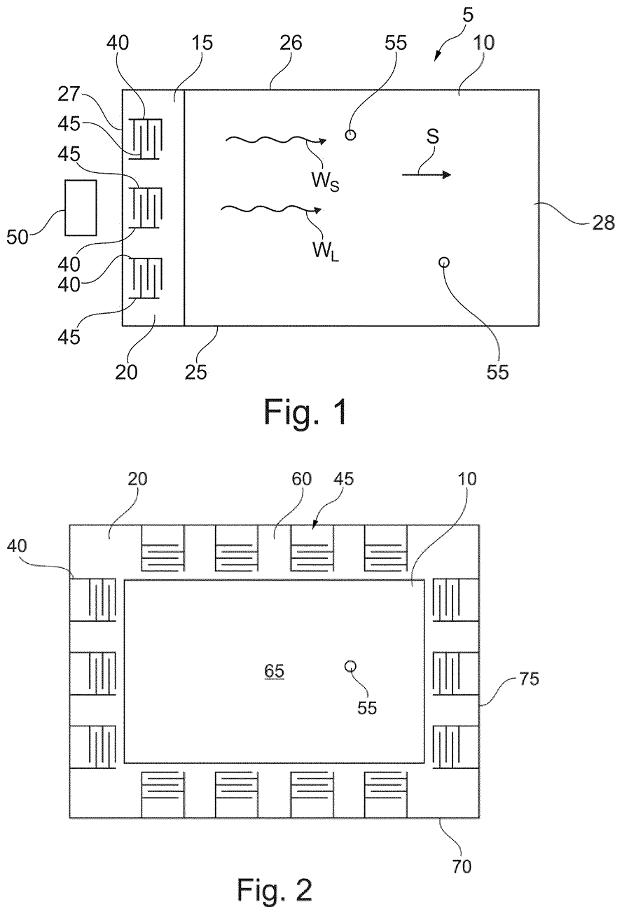

FIGS. 1 and 2 schematically depict, viewed face-on, examples of a device according to the invention,

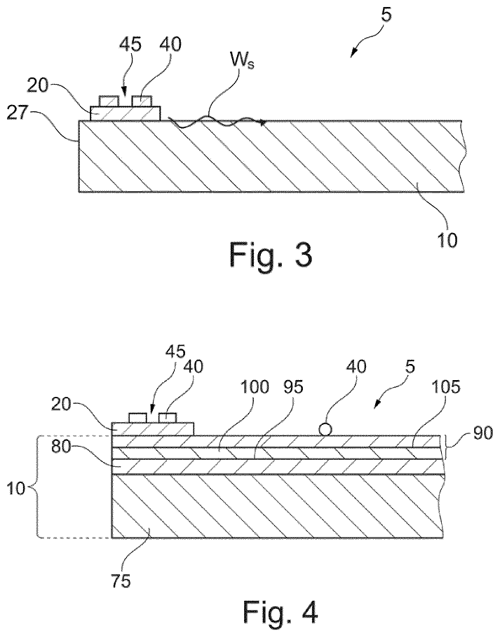

FIGS. 3 to 5 schematically depict, viewed in cross section, examples of a device according to the invention, and

FIGS. 6 to 9 schematically depict further examples of a device according to the invention.

For the sake of clarity, the elements that make up the drawings have not always been drawn to scale.

FIG. 1 illustrates a first example of a device 5 according to the invention, viewed face-on.

The device comprises an optical surface 10 and a transparent optical surface cleaning unit 15.

The optical surface takes the form of a plate which may vary in shape, for example being rectangular as illustrated.

The optical surface cleaning unit 15 comprises a piezoelectric layer 20 which extends in a parallel strip between two opposite edges 25, 26 of the optical surface. The piezoelectric layer further extends on the periphery of the optical surface, along a third edge 27 that connects the opposite edges 25, 26.

The device comprises three pairs of electrodes 40 which have opposite polarities and are interdigital and in contact with the piezoelectric layer, thus forming three wave transducers 45. Naturally, this number of transducers is nonlimiting, provided that it is greater than or equal to two. It may be adapted to suit the size of the device in order to provide optimal cleaning of the optical surface.

The transducers are acoustically coupled to the optical surface, so that the waves that they generate can propagate in the optical surface. The cleaning unit may further comprise a current generator 50 for electrically powering the transducers by means of an electric circuit that has not been depicted in the figure.

The transducers may each generate an ultrasonic surface wave W_{S} or a Lamb wave W_{L}, which propagates in the optical surface in order to move a body 55, for example a raindrop, which may be in contact with the face of the optical surface on which the piezoelectric layer is positioned.

The device may be configured so that the transducers emit an ultrasonic wave toward the edge 28 opposite to the edge 27 along which the piezoelectric layer 20 extends as a strip. The body may thus be moved in the direction S of propagation of the wave and removed from the optical surface via the edge 28.

The device illustrated in FIG. 1 is easy to manufacture. The piezoelectric layer is for example applied using a cathodic sputtering technique and then the electrodes are printed onto the optical surface, for example in a single pass. It is thus possible to quickly position an appreciable number of electrodes on the piezoelectric layer to form transducers, unlike in the devices of the prior art known to the inventors, which require bonding of the transducers in position one by one. As an alternative, the electrodes may be preprinted onto a foil which is then applied to the piezoelectric layer so as to transfer the electrodes onto the piezoelectric layer, for example in the manner of a transfer.

The device depicted in FIG. 2 differs from the one illustrated in FIG. 1 in that the piezoelectric layer delimits a surround 60 which frames a region of optical interest 65. The surround is for example rectangular. The piezoelectric layer may be opaque, allowing an observer looking through the region of optical interest 65 to easily determine the extent of said region. The surround has an exterior contour 70 which coincides with the contour 75 of that face of the optical surface on which the piezoelectric layer is applied. Furthermore, the transducers may be arranged uniformly around the surround. It is thus possible to operate just some of the transducers in order to move a body according to the magnitude of an external force applied to the body, as described for example in application FR 1910589, incorporated by reference.

FIGS. 3 to 5 are schematic views in cross section of portions of examples of a device as depicted in FIGS. 1 and 2.

In the example illustrated in FIG. 3, the optical surface is monolithic and made from an acoustically conducting material, for example glass, and the piezoelectric layer is in contact with the optical surface and positioned at the periphery of the optical surface, against an edge 27. The piezoelectric layer 20 is further positioned between the electrodes 40 of the various transducers and the optical surface 10. When electrically powered, the transducers generate an ultrasonic surface wave W_{S} or a Lamb wave which propagates in the optical surface until it reaches a body in contact therewith. The person skilled in the art easily knows how to determine the frequencies and amplitude of the wave in order to cause the body to move over the optical surface.

The example illustrated in FIG. 4 differs from the example illustrated in FIG. 3 in that the optical surface 10 comprises an acoustically insulating portion 75 completely covering an acoustically conducting portion 80, for example made of glass. The acoustically conducting layer may be mounted removably, for example using a reversible adhesive, on the acoustically insulating layer. Furthermore, although this is optional, the optical surface has a coating 90 completely covering one face 95 of the acoustically conducting portion and made up of a stack of an antireflection layer 100 and a hydrophobic layer 105 so as, for example, to prevent raindrops 40 from spreading over the optical surface 10 and to make them easier to remove. The piezoelectric layer is positioned in contact with the coating opposite the acoustically conducting portion. The coating preferably has a thickness that is small enough with respect to the wavelength of the surface wave generated by the transducer. Thus, the acoustically conducting portion and the transducer are acoustically coupled.

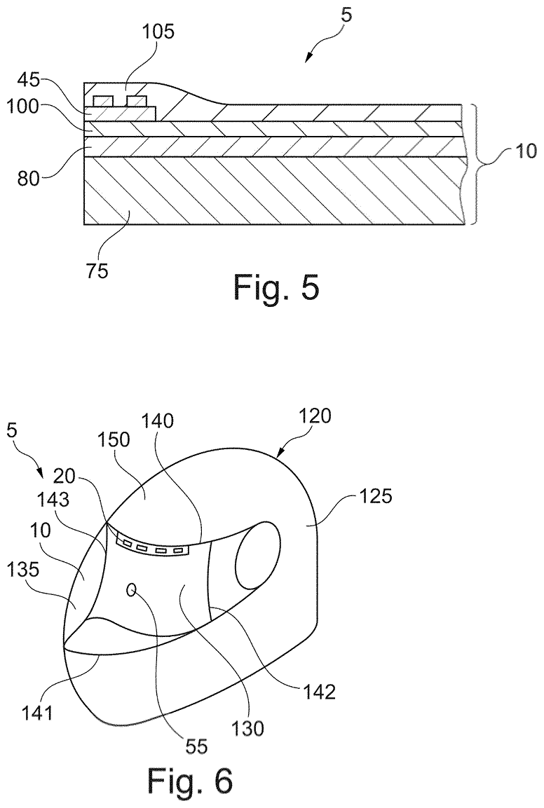

The device illustrated in FIG. 5 differs from the device illustrated in FIG. 6 in that the transducers 45 are sandwiched between the hydrophobic layer 100 and the acoustically conducting portion 80. Thus, the hydrophobic layer protects the transducers.

FIG. 6 schematically depicts a motorcycle helmet 120. The helmet comprises a shell 125, to protect a motorcyclist's head, and has an opening 130 and an optical surface 135 in the form of a transparent and curved visor to protect the motorcyclist's head from precipitation, projectiles and insects.

The visor is mounted on the shell with the ability to rotate and may be moved between a closed position in which the visor closes off the opening and an open position that allows air to pass through the opening toward the motorcyclist's head.

The visor may be made from an acoustically conducting material or may, as illustrated in FIG. 4, have an acoustically insulating portion and an acoustically conducting portion.

A piezoelectric layer 20 is arranged at the periphery of the visor 135. In FIG. 6, it is positioned along the upper edge 140 of the visor. However, other arrangements are conceivable. For example, it may be positioned against the lower edge 141 and/or against the lateral edges 142, 143 to form a surround as illustrated in FIG. 2.

As a preference, the transducers are arranged between the visor 135 and the shell 125 so as to be protected from precipitation. At least in the closed configuration, the piezoelectric layer may be completely superposed on the shell 125, for example on the outside 150 of the shell. In this way, the transducers are hidden from the motorcyclist's sight.

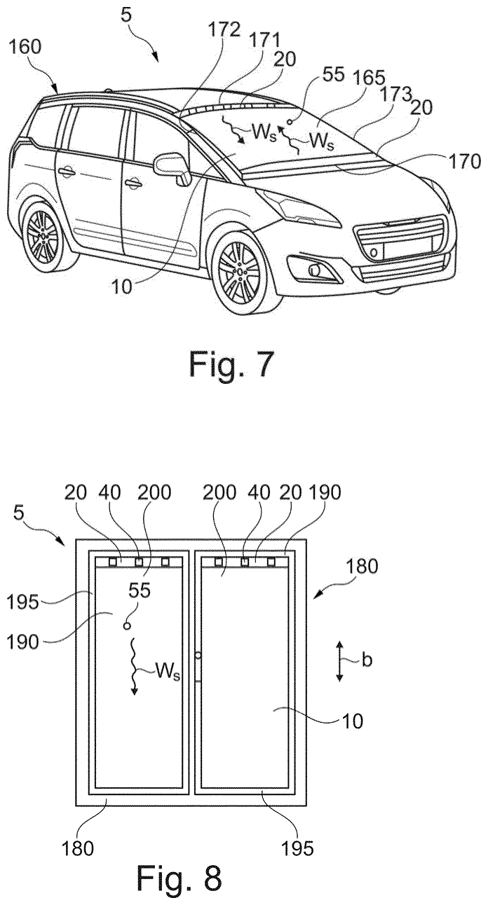

Another alternative is illustrated in FIG. 7. The device 5 depicted there is a motor vehicle 160 having a windshield 165. Piezoelectric layers 20 in strips are positioned along the windshield and extend at the periphery along the lower 170 and upper 171 edges of the windshield and between lateral edges 172, 173 thereof. The piezoelectric layer may be arranged on the face of the windshield opposite to the vehicle-interior compartment. Groups of electrodes 40 of opposite polarities are applied to each piezoelectric layer. Thus, the transducers can each generate an ultrasonic surface wave or a Lamb wave in order to clean off the precipitation that is in contact with the windshield. Such a vehicle may advantageously not be fitted with a wiper.

Another alternative is illustrated in FIG. 8. The device 5 depicted there is a window of a building 180.

The window for example comprises a fixed frame 185 and one or more opening 190, for example two as illustrated, hinged to the fixed frame.

Each opening comprises a framing structure 195 into which glazing 200 is fitted. A piezoelectric layer 20 is arranged at the periphery of the glazing, preferably along the upper part of the glazing, and at least two groups of electrodes are positioned in such a way as to generate acoustic waves W oriented from top to bottom, so as to facilitate the movement of the drops under the effect of gravity G. In the example illustrated, the piezoelectric layer has a part not superposed with the framing structure. In an alternative that has not been depicted, the piezoelectric layer may be sandwiched, for example completely, between the framing structure 195 and the glazing 200 so as to be concealed from the sight of an observer looking through the glazing. Any other glazed element of a building may naturally be envisioned.

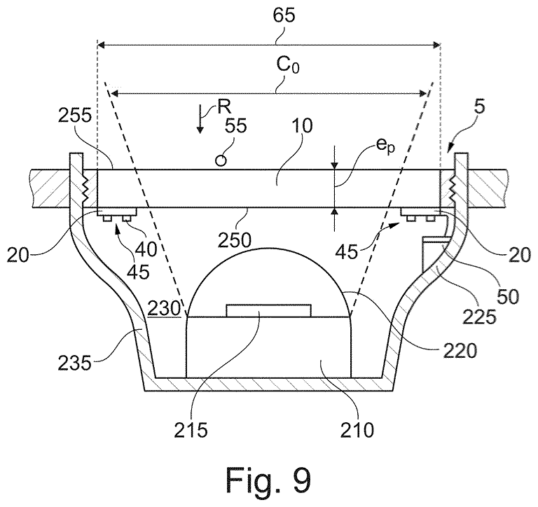

Finally, FIG. 9 depicts yet another alternative of a device 5 according to the invention, which is part of an automated vehicle.

The device comprises an optical surface 10, an optical surface cleaning unit 15 and an item of equipment 210.

The item of equipment comprises a sensor 215 to capture radiation R and a lens to direct the radiation R toward the sensor. As an alternative or in addition, it may comprise an emitter to emit radiation. For example, the item of equipment comprises a lidar which is configured to emit laser radiation and in return capture that part of this laser radiation that has been reflected by an object.

Further, the lens 220 is optional. In an example which is not depicted, the item of equipment does not have one.

The item of equipment defines an optical field C_{O} which corresponds to the portion of space from which it is able to capture radiation. Outside of this optical field, even though the radiation may be able to reach the sensor, the latter is not able to capture it.

Furthermore, the optical surface completely covers the sensor.

In the example illustrated, the optical surface takes the form of a disk of which the thickness eₚ is for example comprised between 0.5 mm and 5 mm. In an alternative, the optical surface may be curved and for example have the shape of a lens.

The device may, as illustrated, comprise a housing 225 which defines a chamber 230 housing the sensor. The chamber may notably be delimited by a solid wall 235 of the housing and by the optical surface 10 so as to be airtight and watertight. The sensor is thus protected against poor weather.

In particular, the optical surface may close off the housing 225. For example, the optical surface is mounted on a ring 240 screwed onto the housing.

The optical surface is thus removable, allowing it to be replaced with ease when it becomes damaged.

The optical surface cleaning unit comprises transducers 45 which are arranged in contact with and acoustically coupled to the optical surface 10. The transducers share the same piezoelectric layer. The cleaning unit further comprises a current generator 50 for electrically powering the transducers.

In the example illustrated in FIG. 9, the transducers are arranged on the face 250 of the optical surface 10 opposite to the face 255 that is to be cleaned. They are preferably configured to generate a Lamb wave that reaches the face that is to be cleaned.

Moreover, the transducers delimit a region of optical interest 65 which is not superposed with the transducers.

As a preference, part of the region of optical interest 65 is contained within the optical field C_{O} of the item of equipment. In other words, the transducers are positioned outside of the optical field of the item of equipment so that they create almost no interference with the radiation passing through the region of optical interest and captured by the sensor.

In order to reduce bulk, as illustrated in FIG. 9, the transducers are arranged at the periphery of the optical surface. In this way, the surface area of the region of optical interest can be maximized.

Of course, the invention is not limited to the exemplary embodiments of the invention that have been provided by way of non-limitative illustrative example.

1. A device comprising:
a transparent optical surface,
an optical-surface cleaning unit comprising a piezoelectric layer and at least two wave transducers,
each wave transducer comprising electrodes of opposite polarities in contact with the piezoelectric layer, and being acoustically coupled with the optical surface in order to generate at least one ultrasonic surface wave or a Lamb wave propagating in the optical surface,
the transducers further being arranged at the periphery of the optical surface.

2. The device as claimed in claim 1, wherein the wave transducer extends from an edge of the optical surface over a distance less than 10%, or even less than 5% of the length of the optical surface.

3. The device as claimed in claim 1, the transducer extending from an edge of the optical surface over a distance less than 30 mm, preferably less than 20 mm, preferably less than 10 mm.

4. The device as claimed in claim 1, the piezoelectric layer forming at least one strip extending over one face of the optical surface.

5. The device as claimed in claim 1, the optical surface comprising a region of optical interest that is not superposed with the transducers and the piezoelectric layer forming a surround at least partially framing the region of optical interest.

6. The device as claimed in claim 1, the wave transducers being in contact with, for example bonded to, the optical surface.

7. The device as claimed in claim 1, the optical surface comprising an acoustically conducting portion, preferably made of glass, the wave transducers being acoustically coupled to the acoustically conducting portion.

8. The device as claimed in the claim 7, the piezoelectric layer being placed in contact with the acoustically conducting portion.

9. The device as claimed in claim 7, the optical surface comprising a stack comprising an acoustically insulating portion and the acoustically conducting portion (80) which are stacked one upon the other.

10. The device as claimed in claim 9, the acoustically conducting portion being mounted removably on the acoustically insulating portion.

11. The device as claimed in claim 1, the electrodes of each transducer being obtained by sputtering or printed, for example ink-jet printed.

12. The device as claimed in claim 11, the electrodes of each transducer being printed on a foil, for example made from a flexible thermoplastic material, and being applied by transferring the foil onto the piezoelectric layer.

13. The device as claimed in claim 1, the thickness of the piezoelectric layer being less than or equal to 5*λ, preferably less than or equal to 1.5*λ, preferably less than or equal to λ, or even less than or equal to 0.5*λ, notably for an ultrasonic surface wave with a frequency comprised between 0.1 MHz and 60 MHz.

14. The device as claimed in claim 1, the piezoelectric layer having a thickness comprised between 1 μm and 300 μm.

15. The device as claimed in claim 1, selected from:
a motorcycle helmet comprising a shell intended to protect a motorcyclist's skull, and the optical surface being a visor mounted on the shell so as to protect all or part of the motorcyclist's face,
a glazed element of a building, and the optical surface being glazing, and
a motor vehicle, and the optical surface being a windshield of the vehicle,
an automated motor vehicle, and the optical surface covering an optical sensor and/or an optical emitter, for example a lidar, photographic equipment, a camera, a radar, an infrared sensor or an ultrasound telemeter, and
a component of a motor vehicle, notably automated, for example selected from a headlamp module, a system containing a collection of various sensors also referred to as a “pod”, at least one side window, a front screen or rear screen and a driving assist unit.
